(19) United States
(12) Patent Application Publication
(10) Pub. No.: US 2008/0032019 A1
(43) Pub. Date: Feb. 7, 2008

(54) REFRIGERATOR CABINET WITH A COMPARTMENT FOR THAWING FROZEN FOODS

(75) Inventors: Urban Wahlby, Conegliano (TV) (IT); Xavier Hue, Orsago (TV) (IT); Robbie Stewart, Orange (AU); Girish Pimputkar, Stockholm (SE)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventem (BE)

(21) Appl. No.: 11/768,649

(22) Filed: Jun. 26, 2007

(30) Foreign Application Priority Data
Dec. 27, 2004 (EP) 04106996.4

(51) Int. Cl. A23L 3/36

(52) U.S. Cl. 426/524

(57) ABSTRACT

A refrigerator cabinet comprising an insulated food storage compartment (2), and evaporator (3) and heating means (4) in thermal relation with said compartment (2); the cabinet comprises a thermal conductor member (5) movably arranged within the compartment (2) between a cooling position and a thawing position, actuating means for driving the thermal conductor member (5) between said positions, control means to energize the heating means (4) depending on said positions, in said cooling position the thermal conductor member (5) being in contact with or adjacent to the evaporator (3) to maximize heat transmission therebetween, so that the thermal conductor member (5) is capable of absorbing heat from said compartment (2), in said thawing position the heating means (4) being energized and the thermal conductor member (5) being spaced apart from the evaporator (3) to thermally separate the compartment (2) from the evaporator.

The present invention relates to a refrigerator cabinet of the domestic type provided with a compartment where frozen foods may be readily thawed out or defrosted for further processing and where hot foods may be readily cooled before being conventionally stored in the refrigerator cabinet.

U.S. Pat. No. 4,002,199 discloses a refrigerator food conditioning appliance comprising a food receptacle for fast-thawing and fast freezing food by the use of a concavo-convex heat energy reflective damper pivotally mounted in an air passage of the receptacle which communicates with an opening in the refrigerated air duct of the compartment. A high energy radiating lamp is located on the pivotal axis of the damper such that a manual control pivots the damper to a first evaporator defrost position dosing the passage with the damper operative to direct heat energy from the lamp via reflective surfaces in the duct to the refrigerator cooling coil. The damper upon being pivoted to a second position, opens the passage and cooperates with the duct reflective surfaces to circulate below freezing air through the receptacle to fast freeze food therein. The damper, upon being pivoted to a third position, doses the passage and reflects heat energy from the lamp into the receptacle to fast-thaw food therein.

This type of refrigerator cabinet has been found to be quite complex especially as regards the heat exchange between the compartment and the cold and hot source.

The aim of the present invention is therefore to solve the noted problems of the cited known art and thus providing a cooling and thawing compartment with a simplified and facilitated operating.

Another object of the present invention is to provide a simpler heat exchange and controlling features with added convenience of handling to the user.

The present invention is embodied with the design and construction characteristics as essentially described and defined with particular reference to the appended claims.

Anyway, features and advantages of the present invention may be more readily understood from the description that is given below by way of a non-limiting example with reference to the accompanying drawings, in which:

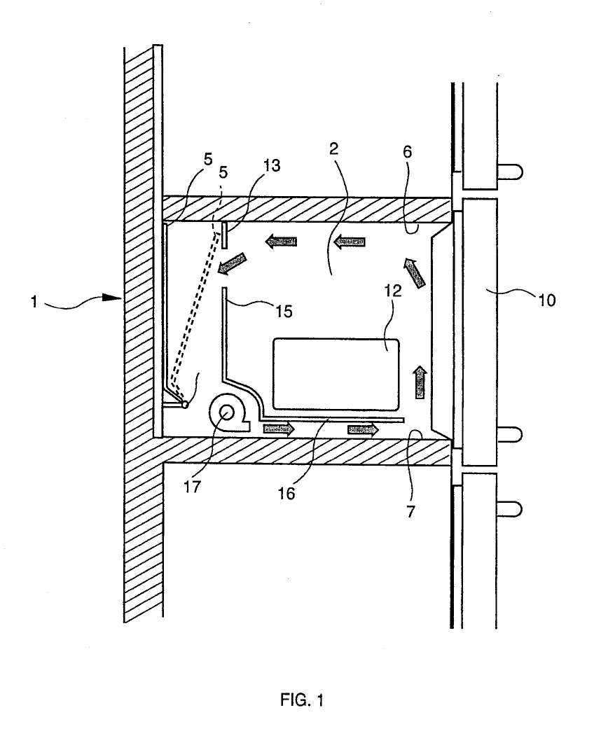

FIG. 1 is a side sectional view of a refrigerator cabinet according to the present invention;

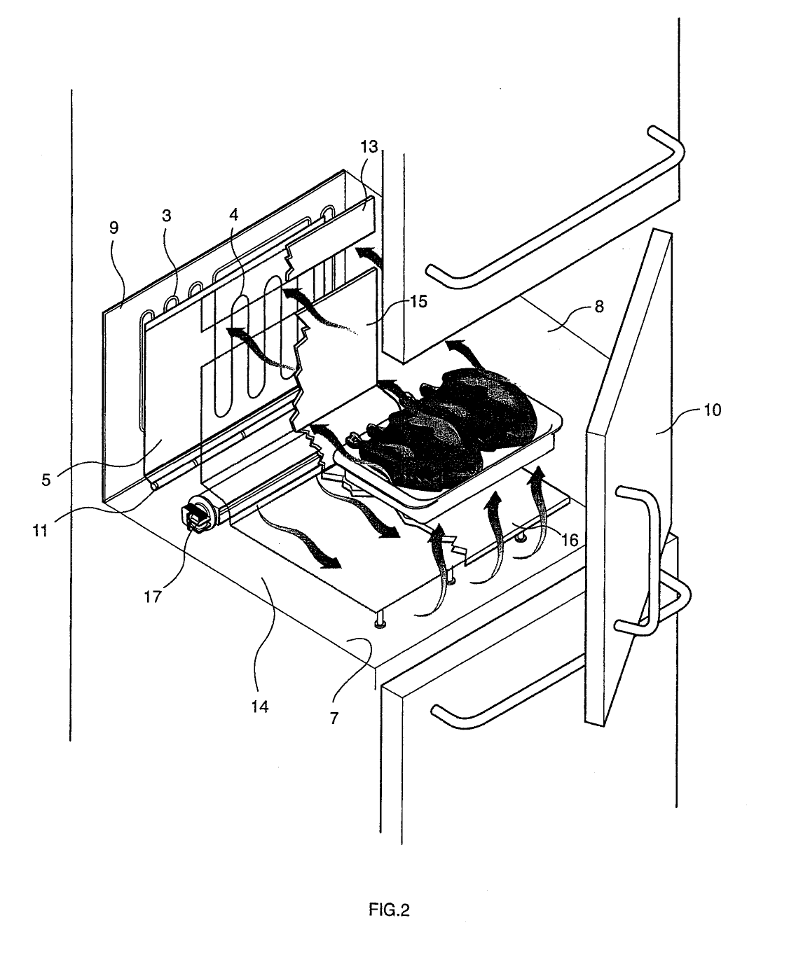

FIG. 2 is a sectional perspective view of the refrigerator cabinet apparatus shown in FIG. 1, with the thermal conductor member in cooling position;

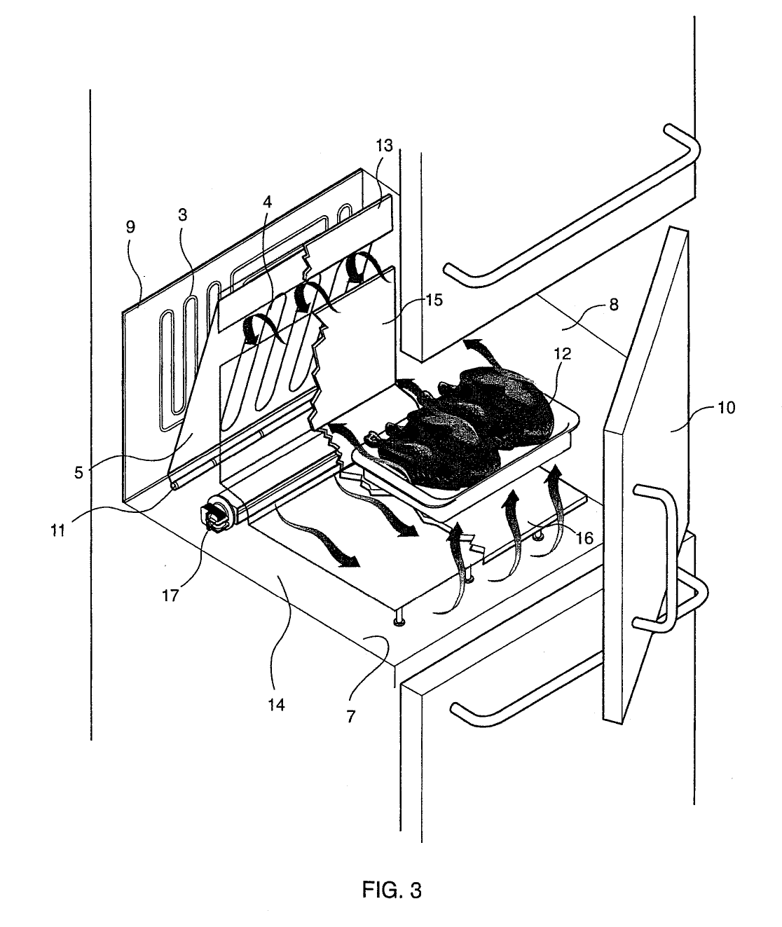

FIG. 3 is a sectional perspective view of the refrigerator cabinet apparatus shown in FIG. 1, with the thermal conductor member in thawing position;

With reference to the FIGS. 1 to 3, an embodiment of an refrigerator cabinet according to the present invention comprises: an insulated food storage compartment 2, an evaporator 3 and heating means 4 in thermal relation with the compartment 2, a thermal conductor member 5 movably arranged within the compartment 2 between a cooling position and a thawing position and control means to energize said heating means 4 depending on said positions.

In the cooling position the thermal conductor member 5 is in contact with or adjacent to the evaporator 3 to maximize heat transmission therebetween, so that the thermal conductor member 5 is capable of absorbing heat from said compartment 2.

In the thawing position the heating means 4 are energized and the thermal conductor member 5 is spaced apart from the evaporator 3 to thermally separate the compartment 2 from the evaporator 3.

Referring to the drawings, a domestic upright refrigerator-freezer cabinet incorporating the compartment according to the present invention is shown in FIG. 1 and indicated by reference numeral 1.

The cabinet 1 is provided with a conventional refrigerating unit comprising a motor-compressor adapted to pressurize refrigerant and deliver it through discharge line to a condenser positioned in a vertically extending plane adjacent the cabinet back wall. Liquefied refrigerant leaves the condenser and flows through a restrictor line, where its pressure is dropped, permitting it to vaporize in an evaporator which is adapted to absorb heat from the cabinet.

The insulated food storage compartment 2 includes a box-shaped housing, preferably molded from plastic material. The housing comprises a top wall 6 and a bottom wall 7 connected to side walls 8 and to a backward wall 9, which is defined by a portion of the evaporator 3 itself or by a liner wall in thermal contact with the evaporator 3. Such backward wall 9 is opposed to a front opening, which provides access to the interior of the compartment and which is closed by an access door 10 connected to the cabinet 1.

In the hereinafter described constructive example of the present invention, the thermal conductor member 5 is pivotally mounted in the compartment 2, and it comprises a plate which is supported for pivotal movement about a rotating axis 11 by means of a hinge provided in correspondence to the backward wall 9. The thermal conductor member 5 is adapted to rotate between the cooling position wherein it stands upright parallel to and in contact to the backward wall 9 and the thawing position wherein it is spaced apart from the backward wall 9, therefore from the evaporator 3, and tilted forward in the direction of the door 10. In the cooling position, the thermal conductor member 5 contacts and overlaps the backward wall 9 of the compartment 2, to enable heat transmission by conduction between the evaporator 3 and thermal conductor member 5. In this position the thermal conductor member 5 is adapted to absorb heat from the compartment 2 for cooling hot food items 12 placed therein.

On the other side in the thawing position the thermal conductor member 5 is prevented to contact the backward wall 9 so as to minimize heat transmission by conduction between the latter and the thermal conductor member 5.

The thermal conductor member plate 5 is adapted to slide along the side walls 8 of the compartment 2 so as to prevent the passage of compartment air between the plate and the side walls 8. The compartment 2 is provided with a baffle 13 arranged in correspondence to and parallel to the upper portion of the backward wall 9 in such a way to form a sort of appendix extending from the top wall 6. In the thawing position, the thermal conductor member 5 at an upper edge thereof is adapted to abut the baffle 13 to prevent compartment air from flowing over the evaporator 2.

As a result the thermal conductor member 5 abutting the baffle 13 prevents compartment air from providing heat exchange transfer with the evaporator 3 hence, by means of the thermal conductor member 5, a thermal separation between the evaporator 3 and the compartment 2 is achieved.

The heating means 4 comprises a resistor arranged on or integrally provided with the thermal conductor member 5 and adapted to be energized by the control means to increase the temperature of the compartment 2 so as to thaw frozen items 12 placed therein.

Clearly, the heating means 4 can also be provided in different positions inside the compartment 2, for example in correspondence to the top wall 6 or the bottom wall 7.

Actuating means for driving the thermal conductor member 5 are provided, which comprise an electric motor arranged in the cabinet 1 or in the compartment 2 and adapted to act the hinge or an electromagnet fixed to the baffle 13 and adapted to move the thermal conductor member 5 between the cooling and thawing position.

It will be appreciated that other actuating means known to the skilled person can be utilised in the present invention. In particular actuating means to allow the thermal conductor member 5 to be manually operated by a user such as a manual lever.

Expediently the control means include an electronic control system adapted to select different operating mode of the compartment according to the user need by energizing the heating means 4 and operating the actuating means.

Temperature sensors are provided inside the compartment to allow the electronic control system to regulate the compartment temperature depending on the operating mode selected.

In the case of the thawing operating mode the control means energize the heating means 4 when the thermal conductor member 5 is in the thawing position described above. In this position in fact the evaporator 3 is prevented to cool the compartment air while the working heating means 4 raise the compartment temperature to defrost frozen foods.

The cooling operating mode provides that the thermal conductor member 5 is in the cooling position to absorb heat from the compartment 2, the heating means 4 being deenergized accordingly.

It is to be noted that the thermal conductor member 5 can be made of an electrically conductor material so that a voltage drop applied to the thermal conductor member 5 provides a joule effect heating.

In a further preferred embodiment of the present invention the thermal conductor member 5 is slidably mounted in the compartment 2. For this purpose guiding means are provided to allow the thermal conductor member 5 to slide inside the compartment in a translation way between the cooling position and the thawing position.

The compartment includes a partition unit 14 to support the food items 12 and to provide an air flow path inside the compartment itself. In practise the partition unit 14 divides the compartment 2 in a first region adapted to contain food items 12 and in a second region wherein the thermal conductor member 5 is adapted to pivot or slide.

The partition unit 14 comprises a vertical surface 15 adapted to form with the baffle 13 an opening which the compartment air is adapted to pass through so as to reach the thermal conductor member 5 and flow in heat exchange transfer relation with the latter, and further it comprises an horizontal surface 16 arranged over the bottom wall 7 of the compartment 2 so as to provide an air passage therebetween for the compartment air coming from the thermal conductor member 5.

Advantageously the baffle 13 can be integrally formed in one piece with the vertical surface 15 and further the whole partition unit 14 can be a single-piece construction or instead the horizontal surface 16 and the vertical surface 15 can be two distinct elements to be assembled.

In a preferred embodiment blower means 17 are provided in the compartment 2 for forcibly circulating air in order to make the compartment temperature even and improve the heat exchange inside the compartment 2.

Advantageously a drain duct is provided for the drainage of the water due to the condensation, which occurs inside the compartment. The drain duct comprise a siphon to provide a hold up of water into the duct in order to prevent diffusion of odour to the external and heat loss through the duct.

Without departing from the innovative concept of the present invention, it is clear for the skilled man that the compartment 2 described above can be assembled as a modular unit adapted to be housed in a conventional refrigerator cabinet.

The operation of the above embodiment of the present invention will be described below.

When the cooling hot food function is chosen by the user from a control panel provided, for example, in the access door, the electronic control system selects the cooling operating mode. Accordingly the actuating means are operated to drive the thermal conductor member 5 to the cooling position, the heating mean 4 are deenergizes, the blower means 17 are operated and the motor-compressor is forced to provide the cooling peak efficiency. The so cooled items are therefore adapted to be stored in the conventional compartment of the refrigerator cabinet. When a predetermined final cooling temperature is reached the cooling operating mode is stopped.

When the thawing frozen food function is chosen by the user the electronic control system selects the cooling operating mode. Accordingly the actuating means are operated to drive the thermal conductor member 5 to the thawing position, the heating mean 4 are energizes, the blower means 17 are operated and the compressor is cut as long as the temperature inside the conventional compartments of the cabinet is adapted to avoid spoilage of food. When a predetermined final thawing temperature is reached the thawing operating mode is stopped.

The compartment 2 according to the present invention is adapted to be utilised also as a normal refrigerator storage compartment at an settable temperature from 0° C. to 8° C. and for this purpose a normal running mode for each given temperature is selected by the electronic control system according to the user need.

To adjust the temperature inside the compartment the electronic control system drives the thermal conductor member to an intermediate position between the cooling and thawing ones and energizes the heating means if it is necessary.

Conclusively, it can therefore be stated that the refrigerator cabinet according to the present invention is a really multivalent and versatile appliance simple in structure and inexpensive to manufacture, the cooling/thawing compartment being adapted to be integrated in a conventional refrigerator with only slight constructional changes, thereby doing away with the serious drawback shared by prior-art machines.

1. A refrigerator cabinet comprising an insulated food storage compartment (2), an evaporator (3) and heating means (4) in thermal relation with said compartment, characterized in that said cabinet comprises a thermal conductor member (5) movably arranged within said compartment (2) between a cooling position and a thawing position and control means to energize said heating means (4) depending on said positions, in said cooling position the thermal conductor member (5) being in contact with or adjacent to the evaporator (3) to maximize heat transmission therebetween, so that the thermal conductor member (5) is capable of absorbing heat from said compartment (2), in said thawing position the heating means (4) being energized and the thermal conductor member (5) being spaced apart from the evaporator (3) to thermally separate the compartment (2) from the evaporator (3).

2. A refrigerator cabinet according to claim 1, characterized in that said thermal conductor member (5) is pivotally mounted in the compartment (2).

3. A refrigerator cabinet according to claim 1, characterized in that said thermal conductor member (5) comprises a plate supported for pivotal movement about a rotating axis (11) by means of a hinge.

4. A refrigerator cabinet according to claim 1, characterized in that said thermal conductor member (5) is slidably mounted in the compartment (2).

5. A refrigerator cabinet according to claim 4, characterized in that guiding means are provided to allow the thermal conductor member 5 to slide inside the compartment in a translation way between the cooling position and the thawing position.

6. A refrigerator cabinet according to any of the preceding claims characterized in that in the thawing position said thermal conductor member (5) is adapted to abut a baffle (13) provided in said compartment (2) to prevent compartment air from flowing over the evaporator (3), said evaporator (3) being prevented to cool the compartment air.

7. A refrigerator cabinet according to any of the preceding claims characterized in that in said heating means (4) comprises a resistor arranged on or integrally provided with the thermal conductor member (5) and adapted to be energized by the control means.

8. A refrigerator cabinet according to any of the preceding claims characterized in that actuating means for driving the thermal conductor member 5 are provided.

9. A refrigerator cabinet according to claim 8, characterized in that said actuating means are adapted to allow the thermal conductor member to be manually operated.

10. A refrigerator cabinet according to claim 9, characterized in that said actuating means comprise a manual lever.

11. A refrigerator cabinet according to claim 8, characterized in that said actuating means comprise an electromagnet fixed to the baffle (13) and adapted to drive the thermal conductor member (5) between the cooling and thawing position.

12. A refrigerator cabinet according to any of the preceding claims, characterized in that in said compartment (2) comprise a partition unit (14) to support the food items (12) and to provide an air flow path inside the compartment (2), the partition unit (14) dividing the compartment (2) in a first region adapted to contain food items (12) and in a second region wherein the thermal conductor member (5) is adapted to move between said cooling and thawing positions.

13. A refrigerator cabinet according to any of the preceding claims, characterized in that in said partition unit (14) comprises a first surface (15) adapted to form with the baffle (13) an opening which the compartment air is adapted to pass through so as to reach the thermal conductor member (5) and flow in heat exchange transfer relation with the latter, and further it comprises a second surface (16) arranged over a bottom wall (7) of the compartment 2 so as to provide an air passage therebetween for the compartment air coming from the thermal conductor member (5).

14. A refrigerator cabinet according to claim 12, characterized in that said baffle (13) is integrally formed in one piece with said first surface (15)

15. A refrigerator cabinet according to any of the preceding claims, characterized in that in said blower means (17) are provided for forcibly circulating air in order to make the compartment temperature even and improve the heat exchange inside the compartment (2).

16. A refrigerator cabinet according to any of the preceding claims characterized in that a drain duct is provided for the drainage of the water due to the condensation which occurs inside the compartment, sad drain duct comprising a siphon to provide a hold up of water into the duct in order to prevent diffusion of odour to the external and heat loss through the duct.
